(19) United States
(12) Patent Application Publication
(10) Pub. No.: US 2021/0318703 A1
(43) Pub. Date: Oct. 14, 2021

(54) LOW DROPOUT VOLTAGE REGULATOR

(71) Applicant: Shanghai Zhaoxin Semiconductor Co., Ltd., Shanghai (CN)

(72) Inventor: Yinji JIN, Beijing (CN)

(21) Appl. No.: 16/923,230

(22) Filed: Jul. 8, 2020

(30) Foreign Application Priority Data
Apr. 10, 2020 (CN) 202010278115.2

(51) Int. Cl. G05F 1/575

(52) U.S. Cl. CPC G05F 1/575

(57) ABSTRACT

A low dropout voltage regulator comprises an error amplifying circuit, an output stage circuit and a load unit. The error amplifying circuit receives a reference voltage signal and a feedback voltage signal, and amplifies the voltage difference between the reference voltage signal and the feedback voltage signal to generate an amplified voltage signal. The output stage circuit couples to the error amplifying circuit, and receives the amplified voltage signal, generate an output voltage signal according to the amplified voltage signal, and generates a feedback voltage signal according to the output voltage signal. The load unit couples to the output stage circuit and receives the output voltage signal.

### CROSS REFERENCE TO RELATED APPLICATIONS

This application claims priority of China Patent Application No. 202010278115.2, filed on Apr. 10, 2020, the entirety of which is incorporated by reference herein.

### BACKGROUND OF THE INVENTION

### Field of the Invention

The present invention relates to a voltage regulator, it relates to a low dropout voltage regulator.

### Description of the Related Art

Generally, low dropout (LDO) regulators have been widely used in a variety of electronic products due to their advantages of low noise, low cost, etc. A low dropout regulator may provide a stable output voltage to serve as a power circuit for other circuits. For example, the low dropout regulator may be used to provide a DC voltage as a DC power during memory chip operation.

However, the output voltage of the low dropout regulator may be unstable or unpredictable due to abnormal operation of the load unit or abnormal power voltage. In addition, in the design of a traditional low dropout regulator, the input-output voltage difference of the low dropout regulator is greater, and the bandwidth may change with the load, making it difficult for the low dropout regulator to achieve a high bandwidth. Furthermore, since the low dropout regulator may not achieve the effect of the high bandwidth, the load change of the low dropout regulator may affect the response speed of the low dropout regulator, that is, reduce the response speed of the low dropout regulator. Therefore, the low dropout regulator still needs to be improved.

### BRIEF SUMMARY OF THE INVENTION

The present invention provides a low dropout voltage regulator, thereby achieving the lower input-output voltage difference, the bandwidth not change with the load, the high bandwidth, the fast response speed, the small overshoot phenomenon and better power supply rejection ratio (PSRR).

In addition, the present invention provides a low dropout voltage regulator, comprising an error amplifying circuit, an output stage circuit and a load unit. The error amplifying circuit is configured to receive a reference voltage signal and a feedback voltage signal, and amplify the voltage difference between the reference voltage signal and the feedback voltage signal to generate an amplified voltage signal. The output stage circuit is coupled to the error amplifying circuit, and is configured to receive the amplified voltage signal, generate an output voltage signal according to the amplified voltage signal, and generate a feedback voltage signal according to the output voltage signal. The load unit is coupled to the output stage circuit, and is configured to receive the output voltage signal.

The low dropout voltage regulator disclosed by the present invention, may effectively satisfy the requirements of the lower input-output voltage difference, the bandwidth not change with the load, the high bandwidth, the fast response speed, the small overshoot and better PSRR.

### BRIEF DESCRIPTION OF THE DRAWINGS

The present invention may be more fully understood by reading the subsequent detailed description and examples with references made to the accompanying drawings, wherein:

FIG. 1 is a schematic view of a low dropout voltage regulator according to an embodiment of the present invention;

FIG. 2 is a schematic view of a low dropout voltage regulator according to another embodiment of the present invention;

FIG. 3 is a schematic view of a low dropout voltage regulator according to another embodiment of the present invention;

FIG. 4 is a schematic view of calculating an open loop gain according to the embodiment of FIG. 3;

FIGS. 5A to 5F are waveform diagrams of a loop gain and a phase margin of a lower dropout voltage regulator when a load capacitance is fixed and a current value of a load signal is changed according to an embodiment of the present invention;

FIGS. 6A to 6B are waveform diagrams of a loop gain and a phase margin of a lower dropout voltage regulator when a load capacitance is changed and a current value of a load current unit is fixed according to an embodiment of the present invention; and

FIGS. 7A to 7C are waveform diagrams of an output voltage signal of a low dropout voltage regulator under when a current value of a load current unit is abruptly changed according to an embodiment of the present invention.

### DETAILED DESCRIPTION OF THE INVENTION

In each of the following embodiments, the same reference number represents an element or component that is the same or similar.

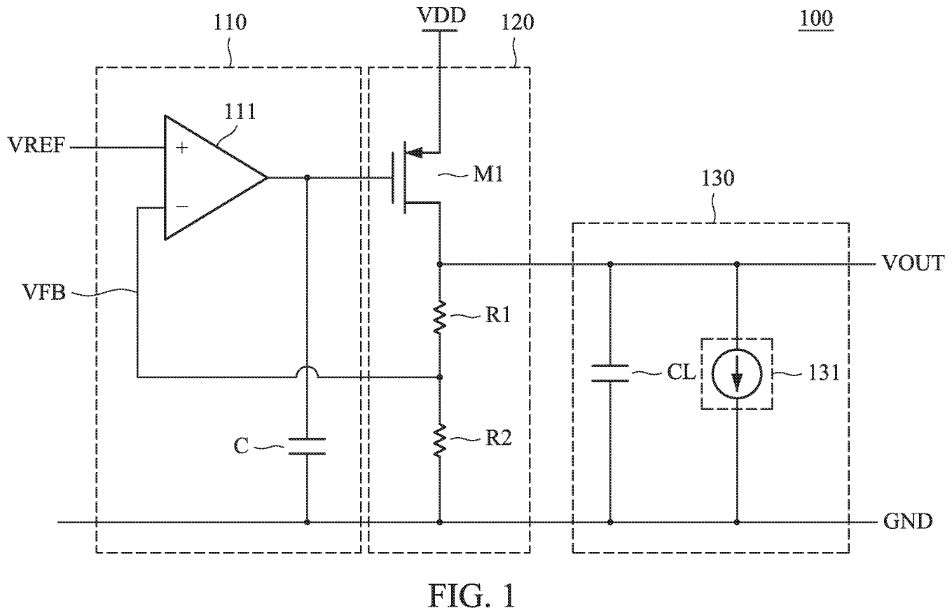

FIG. 1 is a schematic view of a low dropout voltage regulator according to an embodiment of the present invention. Please refer to FIG. 1, in this embodiment, the low dropout voltage regulator 100 comprises an error amplifying circuit 110, an output stage circuit 120 and a load unit 130.

The error amplifying circuit 110 comprises an error amplifier 111 and a compensation capacitor C. The error amplifier 111 has a positive input terminal, a negative input terminal and an output terminal. The positive input terminal (+terminal) of the error amplifier 111 receives a reference voltage signal VREF. The negative input terminal (−terminal) of the error amplifier 111 receives a feedback voltage signal VFB. The error amplifier 111 amplifies the voltage difference between the reference voltage signal VREF and the feedback voltage signal VFB, and the output terminal of the error amplifier 111 transmits an amplified voltage difference to the output stage circuit 120 through the output terminal of the error amplifier 111. The compensation capacitor C may be regarded as a compensation capacitor of the error amplifier 111.

The output stage circuit 120 comprises a P-type transistor M1, a first resistor R1 and a second resistor R2. A gate terminal of the P-type transistor M1 is coupled to the output terminal of the error amplifying circuit 110. A source of the P-type transistor M1 is coupled to a power voltage VDD. A drain terminal of the P-type transistor M1 is coupled to a first terminal of the first transistor R1 and generates an output voltage VOUT. A second terminal of the first resistor R1 is coupled to the negative input terminal of the error amplifier 111 and a first terminal of the second resistor R2, and generates the feedback voltage signal VFB. A second terminal of the second resistor R2 is coupled to a ground voltage GND.

The load unit 130 comprises a load capacitor CL and a load current unit 131. A first terminal of the load capacitor CL is coupled to the first terminal of the first resistor R1. A second terminal of the load capacitor CL is coupled to the ground voltage GND. A first terminal of the load current unit 131 is coupled to the first terminal of the first resistor R1. A second terminal of the load current unit 131 is coupled to the ground voltage GND. A current of the load current unit 131 flows from the first terminal of the load current unit 131 to the second terminal of the load current unit 131.

As shown in FIG. 1, the error amplifier 111 is configured to amplify the voltage difference between the reference voltage signal VREF and the feedback voltage signal VFB. The current of the P-type transistor M1 increases or decreases under the control of the amplified voltage difference to control the magnitude of the output voltage VOUT, so as to charge or discharges the load capacitor CL and remain the output voltage VOUT stable. Specifically, when the output voltage VOUT increases, the amplified voltage difference output by the error amplifier 111 increases, such that the current of the P-type transistor M1 decreases and the output voltage VOUT decreases. When the output voltage VOUT decreases, the amplified voltage difference output by the error amplifier 111 decreases, such that the current of the P-type transistor M1 increases and the output voltage VOUT increases. However, when the current of the load current unit 131 changes greatly, or the power voltage VDD decreases greatly, the stability of the low dropout voltage regulator 100 may be affected.

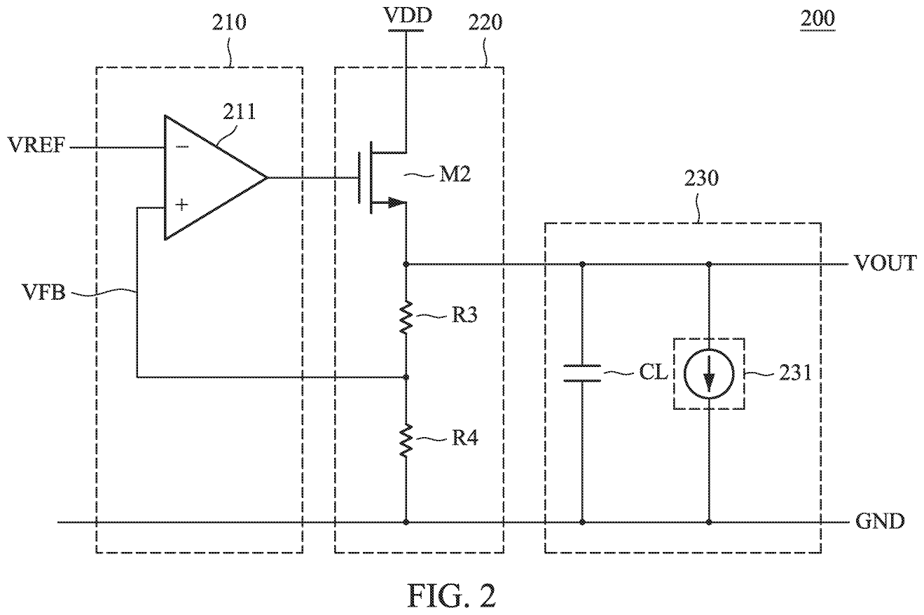

FIG. 2 is a schematic view of a low dropout voltage regulator according to another embodiment of the present invention. Please refer to FIG. 2, in this embodiment, the low dropout voltage regulator 200 comprises an error amplifying circuit 210, an output stage circuit 220 and a load unit 230.

The error amplifying circuit 210 comprises an error amplifier 211. A negative input terminal of the error amplifier 211 receives a reference voltage signal VREF. A positive terminal of the error amplifier 211 receives a feedback voltage signal VFB. The error amplifier 211 amplifies the voltage difference between the reference voltage signal VREF and the feedback voltage signal VFB, and outputs an amplified voltage difference to the output stage circuit 220 through an output terminal of the error amplifier 211.

The output stage circuit 220 comprises a N-type transistor M2, a third resistor R3 and a fourth resistor R4. A gate terminal of the N-type transistor M2 is coupled to the output terminal of the error amplifying circuit 210 and receives the amplified voltage difference. A drain terminal of the N-type transistor M2 is coupled to a power voltage VDD. A source terminal of the N-type transistor M2 is coupled to a first terminal of the third resistor R3 and generates an output voltage VOUT. A second terminal of the third resistor R3 is coupled to the negative input terminal of the error amplifier 211 and a first terminal of the fourth resistor R4, and generates the feedback voltage signal VFB. A second terminal of the fourth resistor R4 is coupled to a ground voltage GND.

The load unit 230 comprises a load capacitor CL and a load current unit 231. A first terminal of the load capacitor CL is coupled to the first terminal of the third resistor R3. A second terminal of the load capacitor CL is coupled to the ground voltage GND. A first terminal of the load current unit 231 is coupled to the first terminal of the third resistor R3. A second terminal of the load current unit 231 is coupled to the ground voltage GND. A current of the load current unit 231 flows to the second terminal of the load current unit 231 from the first terminal of the load current unit 231.

In the embodiment, the error amplifier 211 is configured to amplify the voltage difference between the reference voltage signal VREF and the feedback voltage signal VFB. The current of the N-type transistor M2 increases or decreases under the control of the amplified voltage difference to control the magnitude of the output voltage VOUT, so as to charge or discharge the load capacitor CL to remain the output voltage VOUT stable. Specifically, when the output voltage VOUT increases, the amplified voltage difference output by the error amplifier 211 increases, such that the current of the N-type transistor M2 decreases and the output voltage VOUT decreases. When the output voltage VOUT decreases, the amplified voltage difference output by the error amplifier 211 decreases, such that the current of the N-type transistor M2 increases and the output voltage VOUT increases.

Generally, the low dropout voltage regulator shown in FIG. 1 or FIG. 2 may not achieve the ultra-low voltage difference between the power voltage VDD and the output voltage VOUT, and the stability and bandwidth (frequency) are limited by the load unit 130 or the load unit 230, thereby directly affecting the response speed when the load changes.

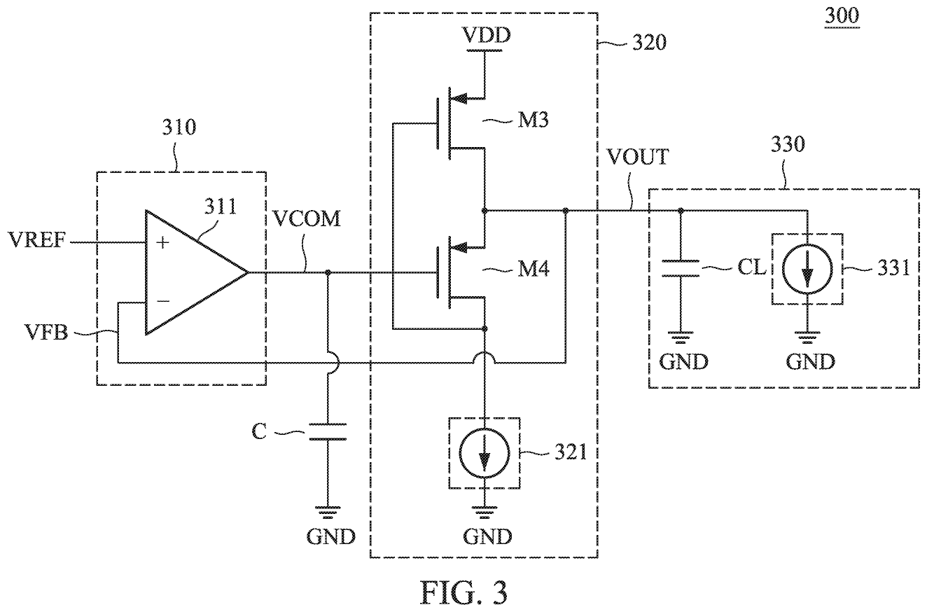

FIG. 3 is a schematic view of a low dropout voltage regulator according to another embodiment of the present invention. Please refer to FIG. 3, in this embodiment, the low dropout voltage regulator 300 comprises an error amplifying circuit 310, an output stage circuit 320 and a load unit 330.

The error amplifying circuit 310 comprises an error amplifier 311 and a compensation capacitor C. The error amplifier 311 has a positive input terminal, a negative input terminal and an output terminal. The positive input terminal of the error amplifier 311 receives a reference voltage signal VREF. The negative input terminal of the error amplifier 311 receives the feedback voltage signal VFB. The error amplifier 311 amplifies the voltage difference between the reference voltage signal VREF and the feedback voltage signal VFB and outputs an amplified voltage difference VCOM through the output terminal of the error amplifier 311. A terminal of the compensation capacitor C is coupled to the output terminal of the error amplifier 311. The other terminal of the compensation capacitor C is coupled to a ground voltage GND. According to an embodiment of the present invention, the compensation capacitor C is a compensation capacitor of the error amplifier 311.

The output stage circuit 320 comprises a P-type transistor M3, a P-type transistor M4 and a current source unit 321. A source terminal of the P-type transistor M3 is coupled to a power voltage VDD. A gate terminal of the P-type transistor M3 is coupled to a drain terminal of the P-type transistor M4. A drain terminal of the P-type transistor M3 is coupled to a source terminal of the P-type transistor M4 and the negative input terminal of the error amplifier 311. The source terminal of the P-type transistor M4 is coupled to the drain terminal of the P-type transistor M3 and the negative input terminal of the error amplifier 311. A gate terminal of the P-type transistor M4 is coupled to the output terminal of the error amplifier 311 and receives the amplified voltage difference VCOM. The drain terminal of the P-type transistor M4 is coupled to a first terminal of the current source unit 321. A second terminal of the current source unit 321 is coupled to the ground voltage GND. A current of the current source unit 321 flows to the second terminal of the current source unit 321 from the first terminal of the current source unit 321. In the embodiment, the drain terminal of the P-type transistor M3 and the source terminal of the P-type transistor M4 generate an output voltage VOUT, and the output voltage VOUT serves directly as the feedback voltage signal VFB and is fed back to the negative terminal of the error amplifier 311.

The load unit 330 comprises a compensation capacitor CL and a load current unit 331. A first terminal of the compensation capacitor CL is coupled to the drain terminal of the P-type transistor M3 and the source terminal of the P-type transistor M4, and receives the output voltage VOUT. A second terminal of the compensation capacitor CL is coupled to the ground voltage GND. A first terminal of the load current unit 331 is coupled to the drain terminal of the P-type transistor M3 and the source terminal of the P-type transistor M4, and receives the output voltage VOUT. A second terminal of the load current unit 331 is coupled to the ground voltage GND. A current of the current source unit 331 flows to the second terminal of the current source unit 331 from the first terminal of the current source unit 331.

According to an embodiment of the present invention, the error amplifier 311 is configured to be an operational amplifier with high gain, thereby allowing that the feedback voltage signal VFB and the reference voltage signal VREF to be equal.

According to an embodiment of the present invention, the P-type transistor M4 comprised by the output stage circuit 320 may be regarded as a source follower, such that the output voltage VOUT may follow the change of the amplified voltage difference VCOM. Specifically, the gate terminal of the P-type transistor M4 serves as the input terminal of the source follower is coupled to the output terminal of the error amplifier 311 and receives the amplified voltage difference VCOM, and the source terminal of the P-type transistor M4 serves as the output terminal of the source follower generates the output voltage VOUT. Therefore, in situations where the output voltage VOUT serves as the feedback voltage signal VFB is output to the negative input terminal of the error amplifier 311, when the current of the load current unit 331 becomes larger and the output voltage VOUT (i.e., the feedback voltage signal VFB) becomes smaller, the feedback voltage signal VFB received by the negative input terminal of the error amplifier 311 is lower than the reference voltage signal VREF received by the positive input terminal of the error amplifier 311, such that the amplified voltage difference VCOM becomes larger. Then, the P-type transistor M4 is operated, such that the output voltage VOUT becomes larger along with the amplified voltage difference VCOM. Accordingly, the output voltage VOUT may be maintained equal to the feedback voltage signal VREF. When the current of the load current unit 331 becomes smaller and the output voltage VOUT (i.e., the feedback voltage signal VFB) becomes larger, the feedback voltage signal VFB received by the negative input terminal of the error amplifier 311 is higher than the reference voltage signal VREF received by the positive input terminal of the error amplifier 311, such that the amplified voltage difference VCOM becomes smaller. Then, the P-type transistor M4 is operated, such that the output voltage VOUT becomes smaller along with the amplified voltage difference VCOM. Accordingly, the output voltage VOUT may always be equal to the feedback voltage signal VREF. Therefore, no matter how the load current (i.e., the current of the load current unit 331) changes, the output voltage VOUT may always be equal to the reference voltage signal VREF through the operation of the error amplifier 311 and the source follower.

According to an embodiment of the present invention, the current source unit 321 serves as a constant current source to provide a constant current signal to the P-type transistor M4. That is, a current signal with a fixed current value is provided to the P-type transistor M4, such that the current flowing through the P-type transistor M4 is constant and is the current of the current source unit 321. Accordingly, the P-type transistor M4 operates in a saturation region, such that the potential of the output voltage VOUT remains stable, and the operation state of the P-type transistor M4 may not change with the current change of the load current unit 331.

According to an embodiment of the present invention, the P-type transistor M3 serves as a buffer transistor to accept the voltage change of the power voltage VDD and the current change of the load current unit 331. Specifically, the source terminal of the P-type transistor M3 is coupled to the power voltage VDD. The gate terminal of the P-type transistor M3 is coupled to the drain terminal of the P-type transistor M4 and the first terminal of the current source unit 321 to form a negative feedback to make the voltage of the gate terminal of the P-type transistor M3 stable. So that the P-type transistor M3 may withstand the voltage change of the power voltage VDD but maybe operate in a saturation region or a linear region. Generally, when the P-type transistor M3 operates in the saturation region, the P-type transistor M3 may accept the current change of the load current unit 331. It is worth noting that due to the P-type transistor M4, the current source unit 321 and the error amplifier 311, even if operates in the linear region, the P-type transistor M3 may withstand the current change of the load current unit 331. Therefore the output voltage VOUT maintains stability regardless of how the current of the load current unit 331 changes or how the power voltage VDD changes, the low drop voltage regulator 300 described by the present invention may operate normally.

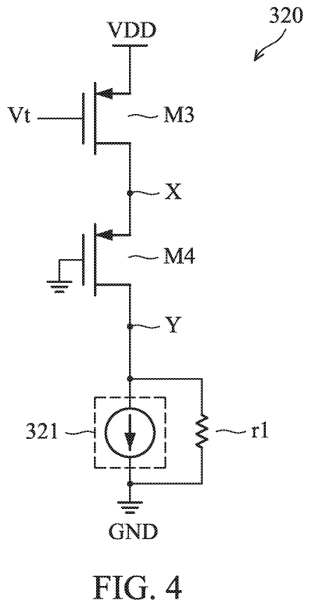

Specifically, the output stage circuit 320 may make a secondary pole far away from the dominant pole, herein the secondary pole corresponds to the output voltage signal VOUT, the dominant pole corresponds to the amplified voltage difference VCOM. That is, the output stage circuit 320 may make the secondary pole far away from the dominant pole in the frequency domain, i.e., in the frequency domain, the frequency of the secondary pole corresponding to the output voltage signal VOUT is far away from the frequency of the dominant pole corresponding to the comparison voltage signal VCOM. This will be analyzed below in conjunction with FIG. 4.

FIG. 4 is a schematic view of calculating an open loop gain according to an embodiment of FIG. 3. Please refer to FIG. 4. For easy calculation, first, the gate terminal of the P-type transistor M4 is regarded as coupling to an AC ground, the gate terminal of the P-type transistor M3 is regarded as coupling to a bias voltage Vt, and an equivalent resistance of the current source unit 321 is set as r1.

The open loop resistance Ryo1 of a node Y may be calculated as follows.

Ryo1=r1//(gm1*ro1*ro2) (1)

Herein r1 is the equivalent resistance of the constant current source of the current source unit 321, gm1 is a transconductance of the P-type transistor M4, ro1 is an output resistance of the P-type transistor M4, and ro2 is an output resistance of the P-type transistor M3.

The open loop gain Ao1 of the output stage circuit 320 may be calculated as follows.

Ao1=−gm2*Ryo1=−gm2*[r1//(gm1*ro1*ro2)] (2)

Herein gm2 is a transconductance of the P-type transistor M3, Ryo1 is an open loop resistance of the node Y, r1 is the equivalent resistance of the constant current source of the current source unit 321, gm1 is the transconductance of the P-type transistor M4, ro1 is the output resistance of the P-type transistor M4, and ro2 is the output resistance of the P-type transistor M3.

The elements that have less of an effect on the open loop resistance Rxo1 are ignored, the open loop resistance Rxo1 of a node X may be calculated as follows.

Rxo1≈(1+r1/ro1)/gm1/ro2 (3)

Herein, Rxo1 is an open loop resistance of the node X, r1 is the equivalent resistance of the constant current source of the current source unit 321, ro1 is the output resistance of the P-type transistor M4, gm1 is the transconductance of the P-type transistor M4, and ro2 is the output resistance of the P-type transistor M3.

After the open loop resistance Rxo1 of the node X is obtained, a closed loop resistance Rxc1 of the node X may be calculated as follows.

Rxc1=Rxo1/(1+|Ao1|) (4)

Herein Rxo1 is the open loop resistance of the node X, and Ao1 is the open loop gain of the output stage circuit 320.

According to an embodiment of the present invention, the constant current provided by the current source unit 321 is mirrored by a current mirror, such that the equivalent resistance r1 of the current source unit 321 and the output resistance ro1 of the P-type transistor M4 may be regarded as approximately equal, i.e., r1≈ro1. Combining equation (2), equation (3) and equation (4), the closed loop resistance of node X may be calculated as follows.

Rxc1=2/(gm1*gm2*ro1) (5)

It can be seen that after removing the influence of the current source unit 321, the magnitude of the resistance value of the closed loop resistance Rxc1 of the output node X of the voltage signal VOUT is determined by the magnitude of gm1*gm2*ro1. Because the P-type transistor M4 operates in the saturation region and the value of the output resistance ro1 is generally several hundred kilo-ohm or more, such that gm1*gm2*ro1 may be maintained at a certain magnitude (for example, several thousand) regardless of the P-type transistor M3 operates in the saturation region or the linear region. Accordingly, the resistance value of the closed-loop output resistance Rxc1 of the output stage circuit 320 is small.

For the low-dropout voltage regulator 300 of FIG. 3, the dominant pole of the low-dropout voltage regulator 300 exists at the output terminal of the error amplifier 311, the dominant pole corresponds to the amplified voltage difference VCOM. A secondary pole exists at the output terminal of the output stage circuit 320, and the secondary pole corresponds to the output voltage signal VOUT. It can be known from the above derivation that the resistance value of the closed loop resistance Rxc1 of the node X (corresponding to the output voltage signal VOUT) is small. Therefore, even if the capacitance value of the load capacitor CL of the load unit 330 is large, the output stage circuit 320 of the low-dropout voltage regulator 300 of the embodiment may push the secondary pole of the output terminal of the output stage circuit 320 away in the frequency domain. Such that, the frequency of the secondary pole is far away from the frequency of the dominant pole, thereby the stability of the loop will not be affected.

When the current of the load current unit 331 of the load unit 330 changes, the current flowing through the P-type transistor M3 also changes. However, the current flowing through the P-type transistor M4 is constant, such that the operation state of the P-type transistor M4 does not change, i.e., the P-type transistor M4 always operates in the saturation region. Even if the P-type transistor M3 accidentally operates in the linear region due to the decrease of the power voltage VDD, as long as the P-type transistor M4 operates in the saturation region, equation (1) to equation (5) still hold. That is, the bandwidth and the stability of the loop shown by the output stage circuit 320 do not change with the current change of the load current unit 331. Therefore, the voltage difference between the power voltage VDD and the output voltage VOUT may be effectively decreased. Such that the bandwidth of the low-dropout voltage regulator 300 does not change with the load, so as to satisfy the requirements of high bandwidth, high response speed and small overshoot, and the increase in bandwidth may also make the power supply rejection ratio better.

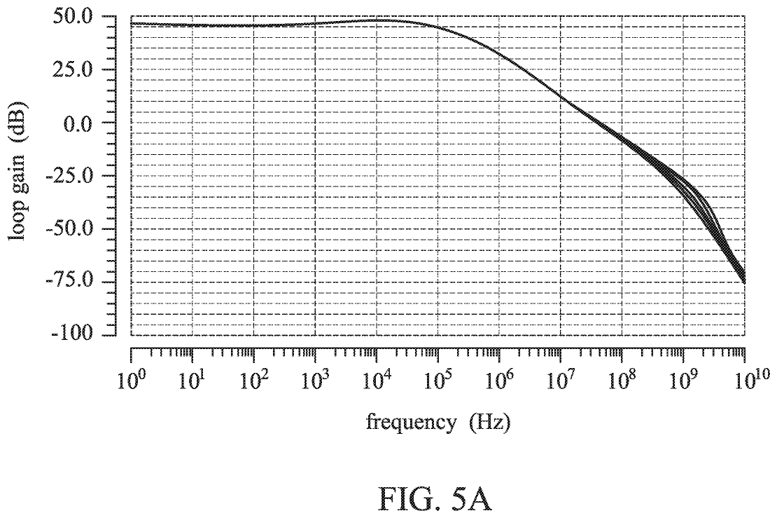

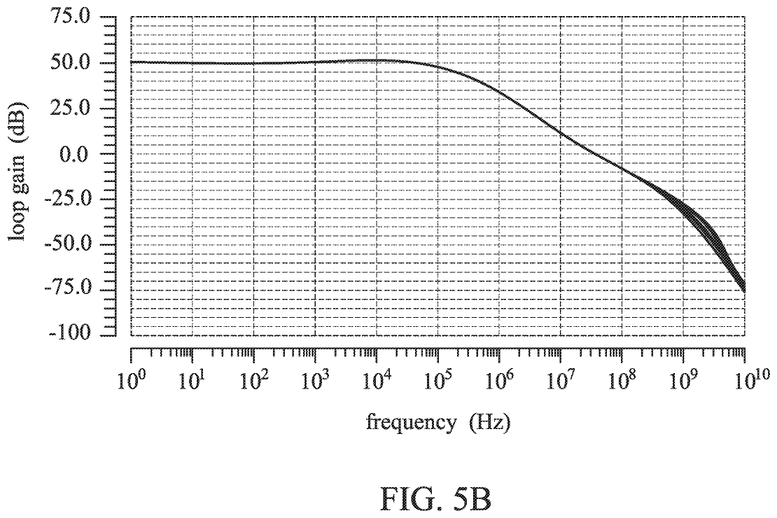

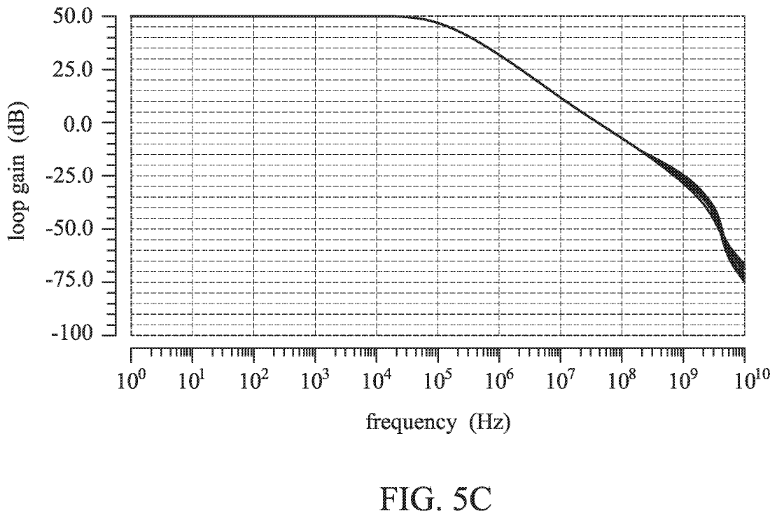

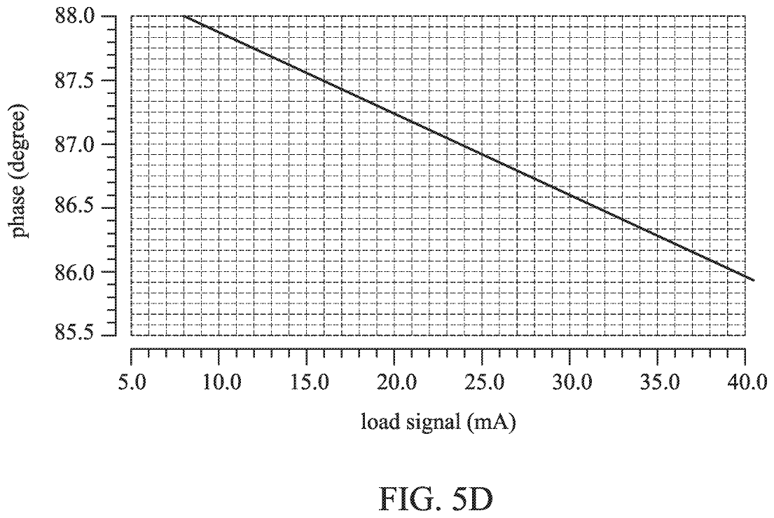

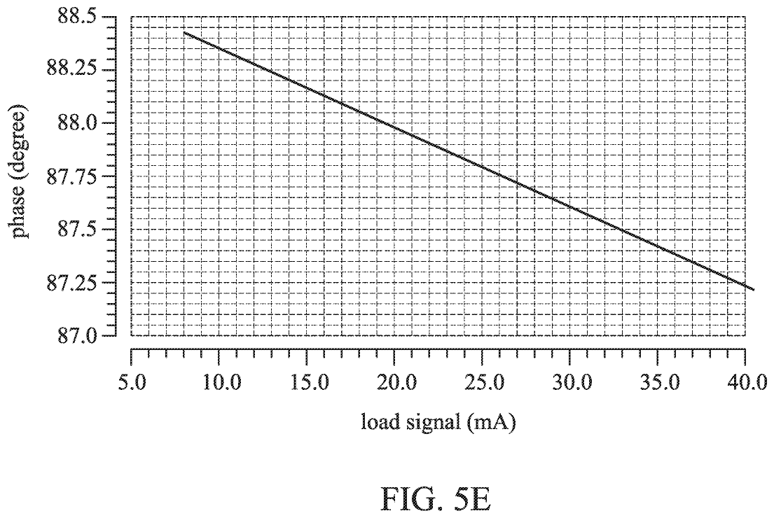

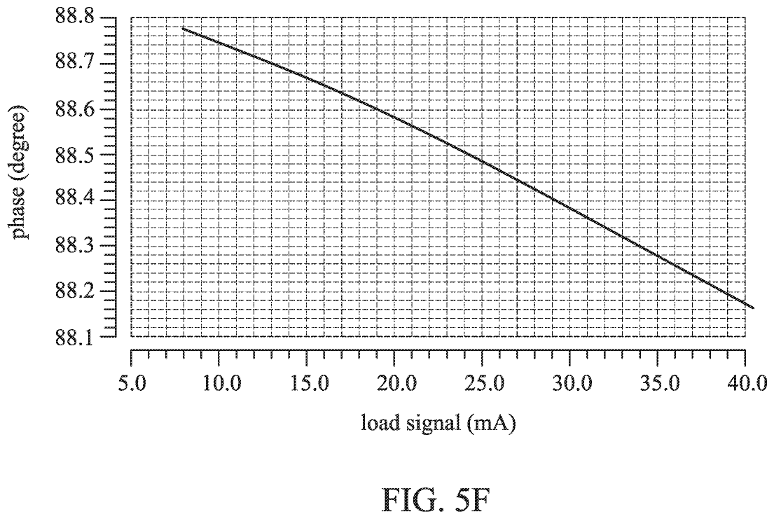

FIGS. 5A to 5F are waveform diagrams of a loop gain and a phase margin of a lower dropout voltage regulator 300 when a load capacitance is fixed and a load current value is changed according to an embodiment of the present invention. Please refer to FIG. 5A to FIG. 5F. The capacitance value of the load capacitor CL is fixed. For example, the capacitance value of the load capacitor CL is fixed as 20 pF. The current value of the load current unit 331 is changed. For example, in a certain period of time (for example, within 1 ns), the current value of the load current unit 331 is changed from 8 mA to 40 mA in steps of 2 mA.

In FIG. 5A and FIG. 5D, the voltage value of the power voltage VDD is, for example, 0.8V. In FIG. 5B and FIG. 5E, the voltage value of the power voltage VDD is, for example, 1V. In FIG. 5C and FIG. 5F, the voltage value of the power voltage VDD is, for example, 1.3V. It can be seen from FIGS. 5A, 5B and 5C that under the three power voltages VDD, in the certain period of time (for example, within 1 ns), when the current of the load current unit 331 is raised from 8 mA to 40 mA in steps of 2 mA, the loop gain curves of the low dropout voltage regulator 300 are not significantly different. For example, it can be seen from FIG. 5A that under the power voltage VDD of 0.8V, in the certain period of time (for example, within 1 ns), the current of the load current unit 331 is raised from 8 mA to 40 mA in steps of 2 mA, the loop gain curves of the low dropout voltage regulator 300 are not significantly different. Similarly, it can be seen from FIG. 5D, FIG. 5E and FIG. 5F that under the three power voltages VDD, in the certain period of time (for example, within 1 ns), the current of the load current unit 331 is raised from 8 mA to 40 mA in steps of 2 mA, the phase margin curves of the low dropout voltage regulator 300 are not significantly different. For example, it can be seen from FIG. 5D that under the power voltage VDD of 0.8V, in the certain period of time (for example, within 1 ns), the current of the load current unit 331 is raised from 8 mA to 40 mA in steps of 2 mA, the phase margin curves of the low dropout voltage regulator 300 are not significantly different. Therefore, it can be seen from FIG. 5A to FIG. 5F that the stability of the bandwidth of the low dropout voltage regulator 300 may not change with the current change of the load signal of the load current unit 331.

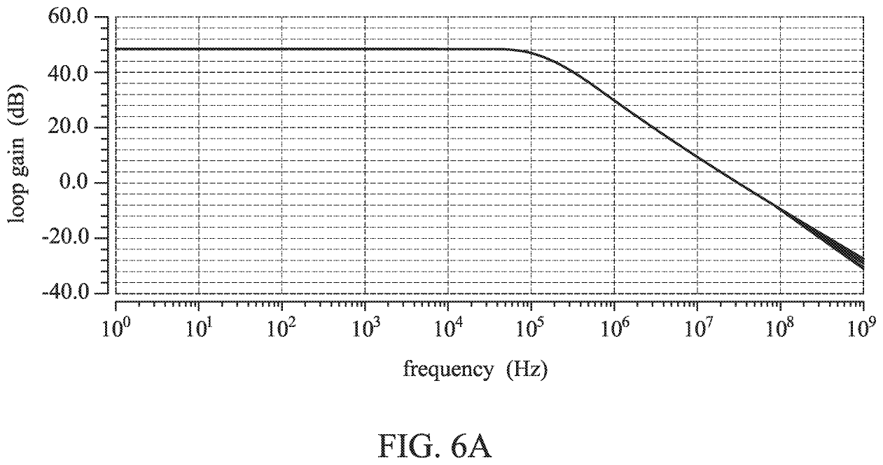

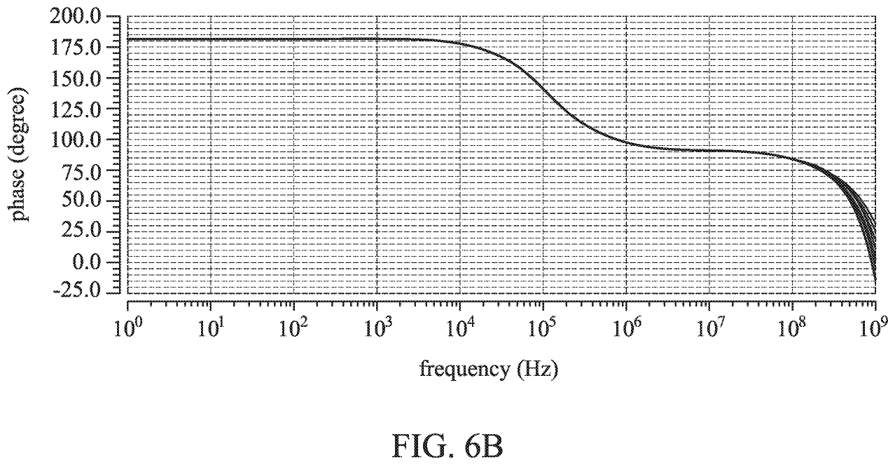

FIGS. 6A and 6B are waveform diagrams of a loop gain and a phase margin of a lower dropout voltage regulator 300 when a load capacitance CL is changed and a current of a load current unit 331 is fixed according to an embodiment of the present invention. FIG. 6A and FIG. 6B correspond to the capacitance change of the load capacitor CL. For example, in a certain period of time (for example, within 1 ns), the capacitance value of the load capacitor CL is changed from 10 pF to 100 pF in steps of 10 pF. The current of the load current unit 331 is fixed, i.e., the current value of the load current unit 331 is, for example, 20 mA.

In FIG. 6A and FIG. 6B, a voltage value of the power voltage VDD is, for example, 1V. It can be seen from FIG. 6A that in the certain period of time (for example, within 1 ns), the capacitance value of the load capacitor CL is changed from 10 pF to 100 pF in steps of 10 pF, the loop gain curves of the low dropout voltage regulator 300 are not significantly different. It can be seen from FIG. 6B that in the certain period of time (for example, within 1 ns), the capacitance value of the load capacitor CL is changed from 10 pF to 100 pF in steps of 10 pF, the phase margin curves of the low dropout voltage regulator 300 are not significantly different. That is, it can be seen from FIG. 6A and FIG. 6B that the stability and the bandwidth of the low dropout voltage regulator 300 may not change with the change of the capacitance value of the load capacitor CL of the load unit 330.

Although the capacitance value of the load capacitor CL of the load unit 330 becomes large, the resistance value of the output resistance Rxc1 of the output stage circuit 320 is small, and the secondary pole may still be pushed far away from the dominant pole and the stability and the bandwidth may not change. That is, even if the capacitance value of the load capacitor CL of the load unit 330 changes, the stability and the bandwidth of the low dropout voltage regulator 300 may not change due to the change of the load capacitor CL.

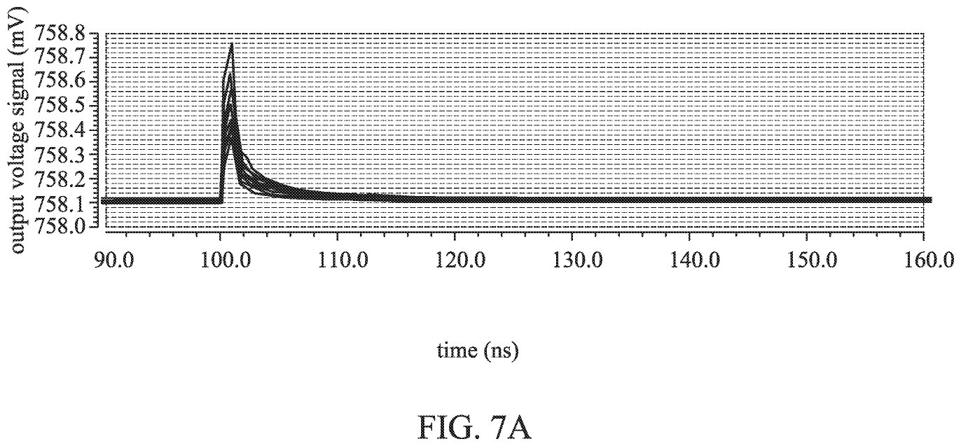

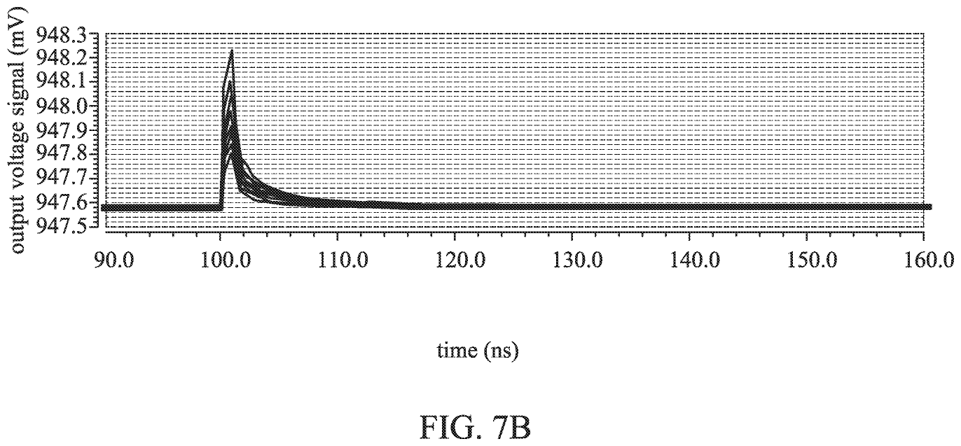

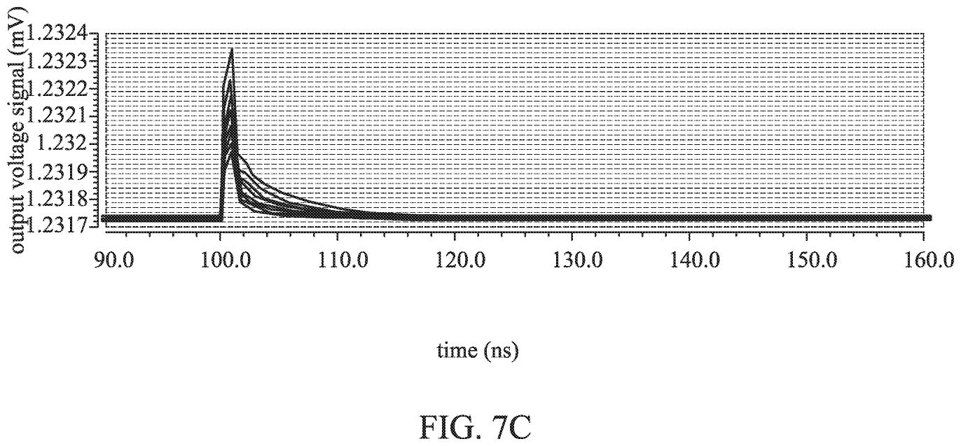

FIGS. 7A to 7C are waveform diagrams of an output voltage signal VOUT of a low dropout voltage regulator 300 when a current of a load current unit 331 is abruptly changed according to an embodiment of the present invention. Please refer to FIG. 7A to FIG. 7C. Assume that the capacitance value of the load capacitor CL is fixed, i.e., the capacitance value of the load capacitor CL is, for example, 20 pF, and in a certain period of time (for example, within 1 ns), the current value of the load current unit 331 is raised from 8 mA to 40 mA in steps of 2 mA.

In FIG. 7A, the voltage value of the power voltage VDD is, for example, 0.8V, and the voltage value of the output voltage signal VOUT is 0.758V. In FIG. 7B, the voltage value of the power voltage VDD is, for example, 1V, and the voltage value of the output voltage signal VOUT is 0.948V. In FIG. 7C, the voltage value of the power voltage VDD is, for example, 1.3V, and the voltage value of the output voltage signal VOUT is 1.232V. It can be seen from FIG. 7A, FIG. 7B and FIG. 7C that the voltage value of the output voltage signal VOUT may be controlled at about 95% of the power voltage VDD, such that the input-output voltage difference is about 5% of the input voltage. The power voltage VDD is the input voltage. In addition, it can be seen that even if an interference of the current of 1 mA is added to the current of the load current unit 331, the overshoot generated by the output voltage signal VOUT is small, and a fast response speed may be maintained.

In summary, according to the low dropout voltage regulator disclosed by the present invention, the error amplifying circuit amplifies the voltage difference of the reference voltage signal and the feedback voltage signal to generate an amplified voltage difference signal. The output stage circuit generates the output voltage signal and feedback the output voltage signal into the input terminal of the error amplifying circuit as a feedback voltage signal. The output stage circuit makes the output voltage signal stable and follow the change of the amplified voltage difference signal, and accept the current change of the load current unit and the change of the power voltage at the same time. Therefore, the purposes of reducing the input-output voltage difference, making the bandwidth not change with the load, achieving high bandwidth, high response speed, and small overshoot are effectively achieved.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A low dropout voltage regulator, comprising:
an error amplifying circuit, receiving a reference voltage signal and a feedback voltage signal, and amplifying a voltage difference between the reference voltage signal and the feedback voltage signal to generate an amplified voltage signal;
an output stage circuit, coupling to the error amplifying circuit, and receiving the amplified voltage signal, generating an output voltage signal according to the amplified voltage signal, and generating the feedback voltage signal according to the output voltage signal; and
a load unit, coupling to the output stage circuit and receiving the output voltage signal.

2. The low dropout voltage regulator as claimed in claim 1, wherein the error amplifying circuit comprises:
an error amplifier, comprising a first input terminal, a second input terminal, and an output terminal, wherein the first input terminal of the error amplifier receives the reference voltage signal, the second input terminal of the error amplifier receives the feedback voltage signal, and the output terminal of the error amplifier outputs the amplified voltage signal.

3. The low dropout voltage regulator as claimed in claim 2, further comprising:
a compensation capacitor, comprising a first terminal and a second terminal, wherein the first terminal of the compensation capacitor is coupled to the output terminal of the error amplifier, and the second terminal of the compensation capacitor is coupled to a ground.

4. The low dropout voltage regulator as claimed in claim 1, wherein the output circuit comprises:
a first transistor, comprising a first terminal, a second terminal, and a third terminal, wherein the first terminal of the first transistor is coupled to the error amplifying circuit and receives the amplified voltage signal, and the second terminal of the first transistor is coupled to the error amplifying circuit and takes the output voltage signal as the feedback voltage signal;
a second transistor, comprising a first terminal, a second terminal and a third terminal, wherein the first terminal of the second transistor is coupled to the third terminal of the first transistor, the second terminal of the second transistor is coupled to a power voltage, and the third terminal of the second transistor is coupled to the second terminal of the first transistor; and
a current unit, comprising a first terminal and a second terminal, wherein the first terminal of the current unit is coupled to the third terminal of the first transistor, the second terminal of the current unit is coupled to a ground, and the current unit is configured to provide a current signal.

5. The low dropout voltage regulator as claimed in claim 4, wherein the first transistor operates in a saturation region.

6. The low dropout voltage regulator as claimed in claim 4, wherein the second transistor operates in a saturation region or a linear region.

7. The low dropout voltage regulator as claimed in claim 4, wherein the current signal provided by the current unit is a mirror current.

8. The low dropout voltage regulator as claimed in claim 1, wherein the load unit comprises:
a load capacitor, comprising a first terminal and a second terminal, wherein the first terminal of the load capacitor is coupled to the output stage circuit and receives the output voltage signal, and the second terminal of the load capacitor is coupled to a ground; and
a load current unit, comprising a first terminal and a second terminal, wherein the first terminal of the load current unit is coupled to the first terminal of the compensation capacitor, the second terminal of the load current unit is coupled to the ground, and the load current unit is configured to generate a load current signal.

9. The low dropout voltage regulator as claimed in claim 1, wherein the output voltage signal is stable and is equal to the reference voltage signal.

10. The low dropout voltage regulator as claimed in claim 1, wherein an error between the output voltage signal and a power voltage is as low as 5%.
